(19) United States
(12) Patent Application Publication
(10) Pub. No.: US 2012/0006300 A1
(43) Pub. Date: Jan. 12, 2012

(54) FUEL INJECTION VALVE

(75) Inventor: Akira Akabane, Miyagi (JP)

(73) Assignee: KEIHIN CORPORATION, Tokyo (JP)

(21) Appl. No.: 13/256,606

(22) PCT Filed: Mar. 15, 2010
(86) PCT No.: PCT/JP2010/054325

§ 371 Date: Sep. 14, 2011

(30) Foreign Application Priority Data
Mar. 30, 2009 (JP) 2009083535

(51) Int. Cl. F02M 61/14

(52) U.S. Cl. 123/470

(57) ABSTRACT

A fuel injection valve is provided which includes a valve seat member (3) having a valve seat (8) and a nozzle (10) that is provided so as to be connected to a front end part of the valve seat member (3) so as to be positioned on the downstream side of the valve seat (8) and has a plurality of fuel discharge holes (11b) arranged around an axis (A) of the valve seat member (3), wherein the angle formed between the center line (Lb) of each of the fuel discharge holes (11b) and an inner end face (10a) of the nozzle (10) is set at an obtuse angle (α) on the side closer to the outer periphery of the nozzle (10) with respect to the center line (Lb) and an acute angle (β) on the side closer to the center of the nozzle (10) with respect to the center line (Lb), and fuel injected from a fuel discharge hole (10b) produces a fuel spray form (fb) as a fuel film having an arc-shaped cross section with a convex face facing the nozzle outer periphery side. This enables the loss of fuel injection energy to be reduced and the outline of a fuel spray form produced by injected fuel to be clear, thus improving penetration properties.

This application is a National Stage entry of International Application No. PCT/JP2010/054325, filed Mar. 15, 2010, which claims priority to Japanese Patent Application No. 2009-083535 filed Mar. 30, 2009, the disclosure of the prior applications are incorporated in its entirety by reference.

### TECHNICAL FIELD

The present invention relates to a fuel injection valve that is mainly used in a fuel supply system of an internal combustion engine and, in particular, to an improvement of a fuel injection valve that includes a valve body, a valve seat member having an annular conical valve seat on which the valve body is seated in an openable and closable manner, and a nozzle that is provided so as to be connected to a front end part of the valve seat member so as to be positioned on the downstream side of the valve seat and has a plurality of fuel discharge holes arranged around the axis of the valve seat member, an inner end face of the nozzle, on which inlets of the plurality of fuel discharge holes open, being a concave conical face or spherical face having a diameter that decreases in going toward the front of the nozzle.

### BACKGROUND ART

Such a fuel injection valve is already known, as disclosed by Patent Document 1 below.

### PRIOR ART DOCUMENTS

### Patent Documents

Patent Document 1: Japanese Patent Application Laid-open No. 2006-207419

### SUMMARY OF THE INVENTION

### Problems to be Solved by the Invention

In such a conventional fuel injection valve, when the valve body is open, the main flow of fuel that has passed through the valve seat is made to collide directly with an inner face of the fuel discharge hole, thus promoting atomization of the injected fuel. However, in such an arrangement, due to the main flow of fuel being made to collide directly with the inner face of the fuel discharge hole, the loss of fuel injection energy is large, and when fuel passes through the fuel discharge hole, fuel flow separation occurs on an inside face, on the nozzle outer periphery side, of the fuel discharge hole, thus making the outline of a fuel spray form produced by the injected fuel unclear, there still being room for improvement of penetration properties with regard to these aspects.

The present invention has been accomplished in light of such circumstances, and it is an object thereof to provide a fuel injection valve that reduces the loss of fuel injection energy and makes the outline of a fuel spray form produced by injected fuel clear, thus improving penetration properties and, moreover, improving atomization in an extremity part of the fuel spray form close to an engine intake valve, thereby contributing to an improvement of engine combustion efficiency and, consequently, to an improvement of output and fuel consumption performance.

### Means for Solving the Problem

In order to attain the above object, according to a first aspect of the present invention, there is provided a fuel injection valve in which, in a state in which the fuel injection valve is mounted on an intake manifold of an internal combustion engine, two independent fuel spray-form beams produced from injected fuel are supplied toward first and second ports, the fuel injection valve comprising a valve body, a valve seat member having an annular conical valve seat on which the valve body is seated in an openable and closable manner, and a nozzle that has a plurality of fuel discharge holes and is provided in a front end part of the valve seat member so as to be positioned on the downstream side of the valve seat, an inner end face of the nozzle, on which inlets of the plurality of fuel discharge holes open, being a conical or spherical face that is concave in going toward the front of the nozzle, characterized in that the plurality of fuel discharge holes are arranged on the same virtual circle having an axis of the valve seat member as the center, these fuel discharge holes being divided into first and second fuel discharge hole groups each comprising at least three fuel discharge holes producing the fuel spray-form beam, the angle formed between the center line of each of the fuel discharge holes and the inner end face of the nozzle is set at an obtuse angle on the side closer to the outer periphery of the nozzle with respect to the center line and an acute angle on the side closer to the center of the nozzle with respect to the center line, and fuel discharge holes positioned on opposite outermost sides of each of the fuel discharge hole groups are arranged so that the center lines thereof intersect each other at an intersection point in front of the nozzle and toward one side, closer to the center of the nozzle, of an extension of the center line of the fuel discharge hole positioned at the middle or the vicinity of the respective fuel discharge hole group.

Further, according to a second aspect of the present invention, in addition to the first aspect, the first and second fuel discharge hole groups are positioned on opposite sides of one plane containing the axis as a boundary, and a gap between the fuel discharge holes in each of the fuel discharge hole groups is set smaller than a gap between the two fuel discharge hole groups.

Moreover, according to a third aspect of the present invention, in addition to the first or second aspect, the valve seat member and the nozzle are formed integrally using the same material.

### Effects of the Invention

In accordance with the first aspect of the present invention, fuel injected from the fuel discharge hole can produce a fuel spray form as a fuel film having an arc-shaped cross section with a convex face facing the nozzle outer periphery side. This fuel spray form has a clear outline and does not cause wasteful scattering; furthermore, in the fuel discharge hole there is no direct collision of fuel flow with its inner face, the loss of injection energy is small, and the penetration properties of the fuel spray form can therefore be improved. Further, with regard to each fuel discharge hole group, fuel spray forms injected and produced from fuel discharge holes at opposite outside positions are inclined toward the fuel spray form injected and produced from the fuel discharge hole at the middle position, confluence therewith is promoted, a fuel spray-form beam having a clear outline can be produced, and it is thereby possible to enhance further effectively the penetration properties of the first and second fuel spray-form beams.

Moreover, since the fuel film having an arc-shaped cross section, which produces the fuel spray form, increases in diameter and greatly decreases in film thickness in going toward the engine intake valve, a good atomization state is given due to high speed contact with air, and therefore atomization in an extremity part of the fuel spray form close to the intake valve can be improved. In accordance with such a fuel spray form, it is possible to prevent fuel from becoming attached to an intake port inner wall, improve engine combustion efficiency, and contribute to an improvement of output and fuel consumption performance.

Furthermore, the fuel discharge holes therefore have center lines that are substantially parallel to the axis of the valve seat member, and machining of each fuel discharge hole by means of piercing or a laser can be carried out easily without being affected by surrounding objects, such as a peripheral wall of the valve seat member.

In accordance with the second aspect of the present invention, with regard to each of the first and second fuel discharge hole groups, by fuel injected from the plurality of fuel discharge holes, two independent first and second fuel spray-form beams can thus be produced, the outlines of these fuel spray-form beams are also clear, there is no wasteful scattering, and high penetration properties can be obtained.

In accordance with the third aspect of the present invention, due to integration of the valve seat member and the nozzle using the same material, not only can a step of joining to the valve seat member by welding, etc. be omitted and the production step and the structure be made simple, but it is also possible to prevent the valve seat from being distorted by a joining step and improve the precision of the valve seat and, consequently, the valve sealing. Furthermore, it is possible to easily carry out machining of the fuel discharge hole at the correct position with respect to the valve seat, and dimensional control can also be carried out easily.

### BRIEF DESCRIPTION OF DRAWINGS

FIG. 1 is a cross-sectional plan view of an engine equipped with a fuel injection valve related to the present invention (first embodiment).

[FIG. 2] A longitudinal cross-sectional side view of the fuel injection valve (first embodiment).

[FIG. 3] An enlarged view of part 3 in FIG. 2 (first embodiment).

[FIG. 4] A sectional view along line 4-4 in FIG. 3 (first embodiment).

[FIG. 5] A view from arrow 5 in FIG. 4 (first embodiment).

[FIG. 6] An enlarged view of an essential part in FIG. 3 showing the state of production of a fuel spray form when a valve body is open (first embodiment).

[FIG. 7] A view, corresponding to FIG. 3, showing a modified example of the fuel injection valve (first embodiment).

### EXPLANATION OF REFERENCE NUMERALS AND SYMBOLS

I Fuel injection valve
A Axis of valve seat member
G1, G2 First and second fuel discharge hole groups
C Virtual circle
La, Lb, Lc Center line of fuel discharge hole
D1 Gap between first and second fuel discharge hole groups
D2 Gap between adjacent fuel discharge holes
α Obtuse angle
β Acute angle
3 Valve seat member
8 Valve seat
10 Nozzle
10a Inner end face of nozzle
11a, 11b, 11c Fuel discharge hole
18 Valve body

### MODE FOR CARRYING OUT THE INVENTION

A mode for carrying out the present invention is explained below by reference to a preferred embodiment of the present invention shown in the attached drawings.

### Embodiment 1

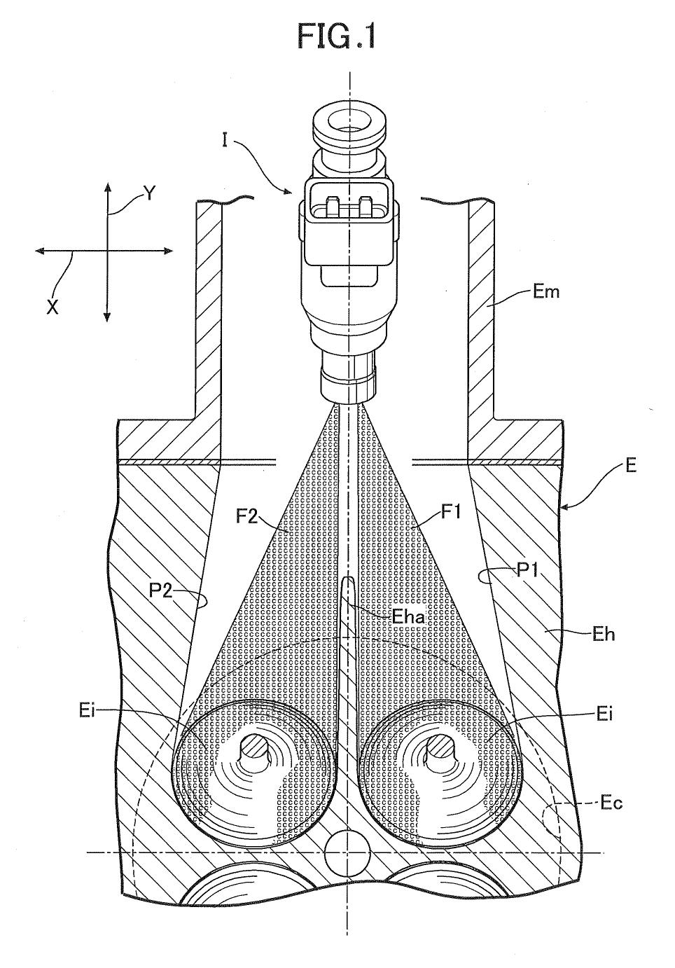

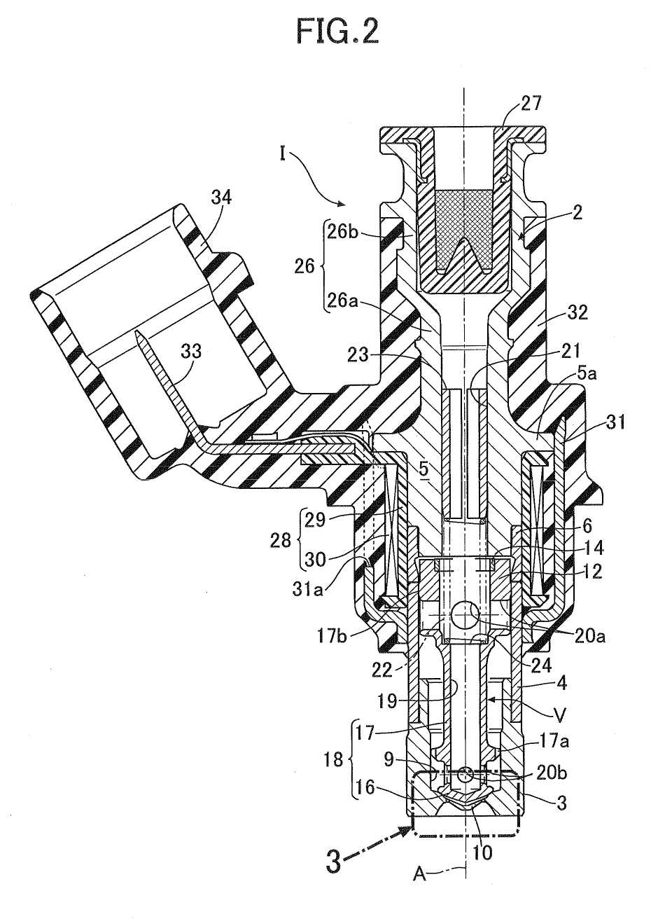

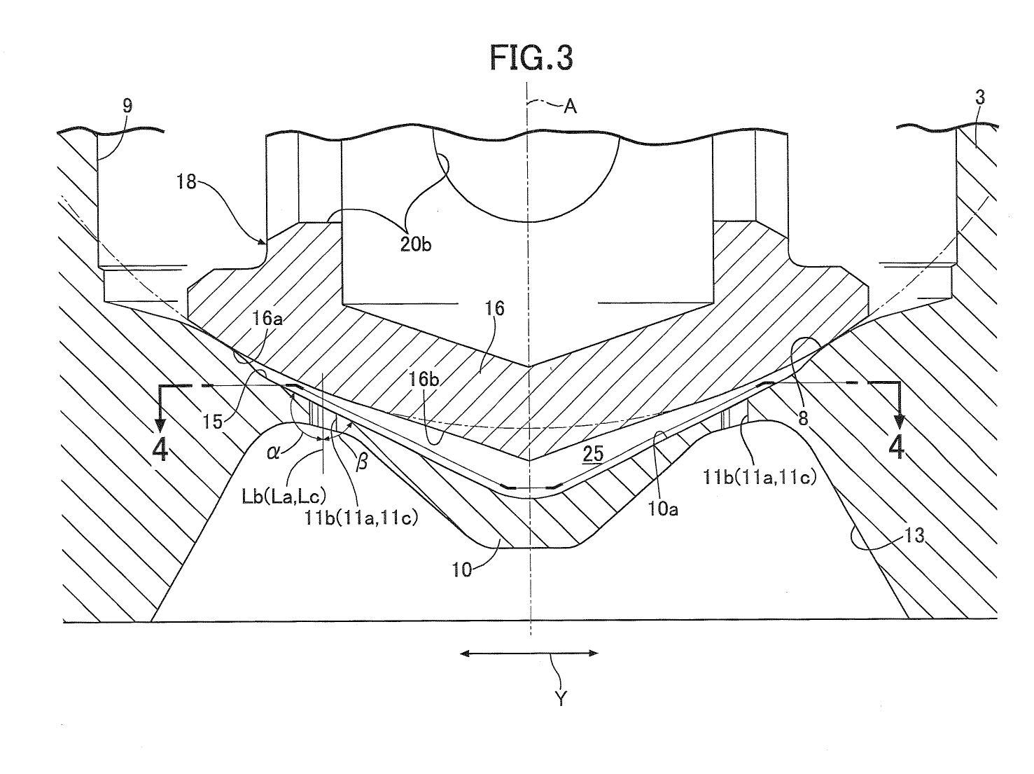

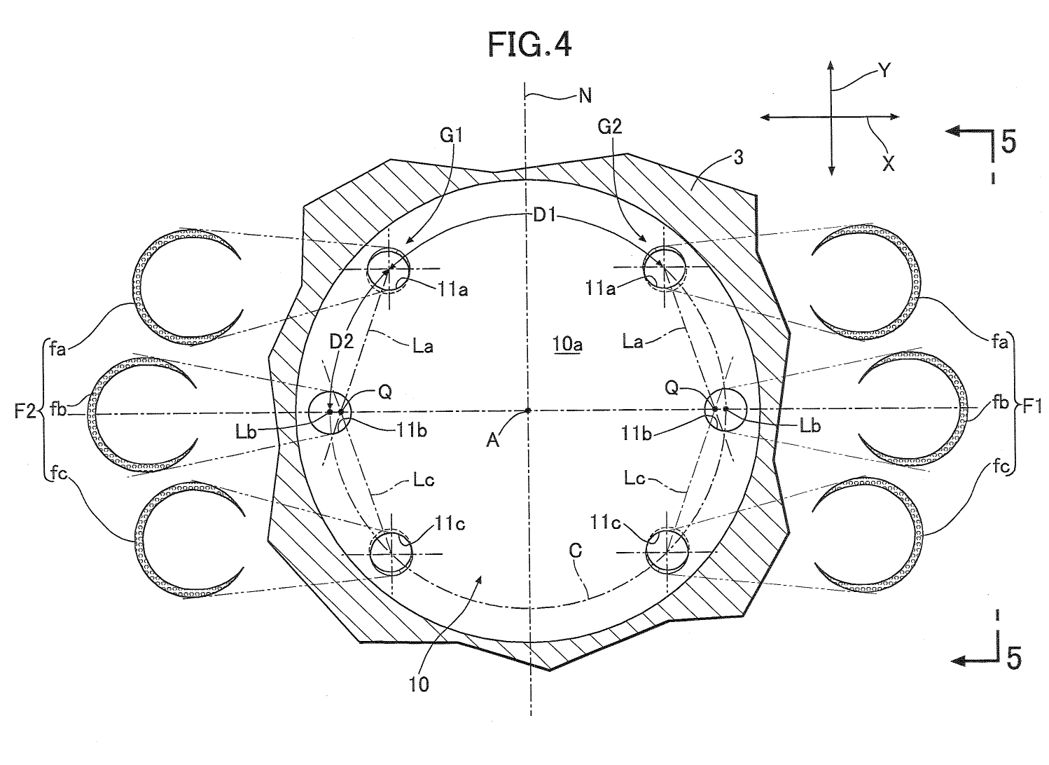

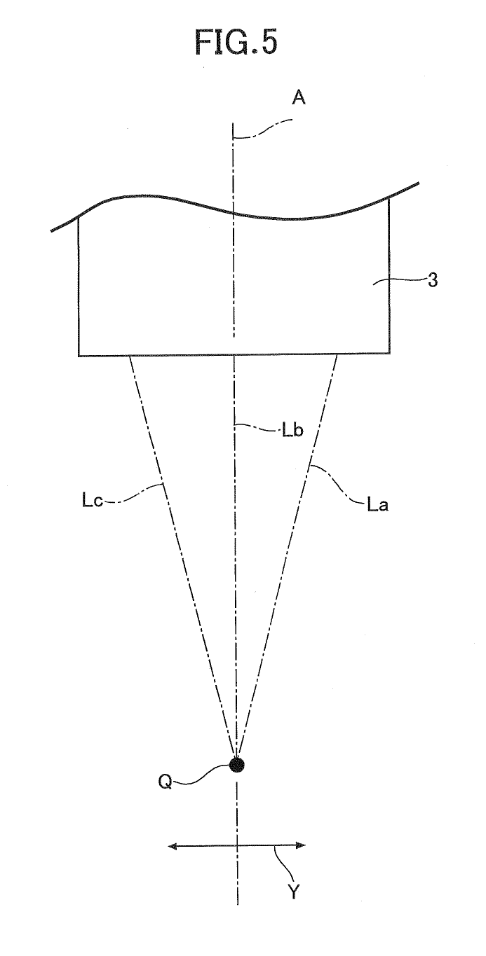

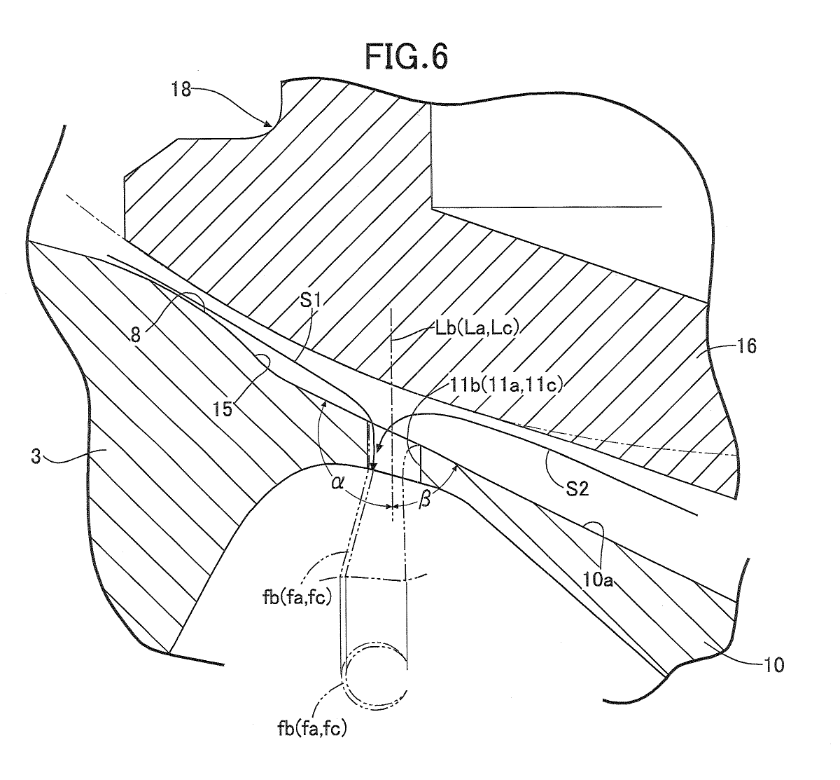

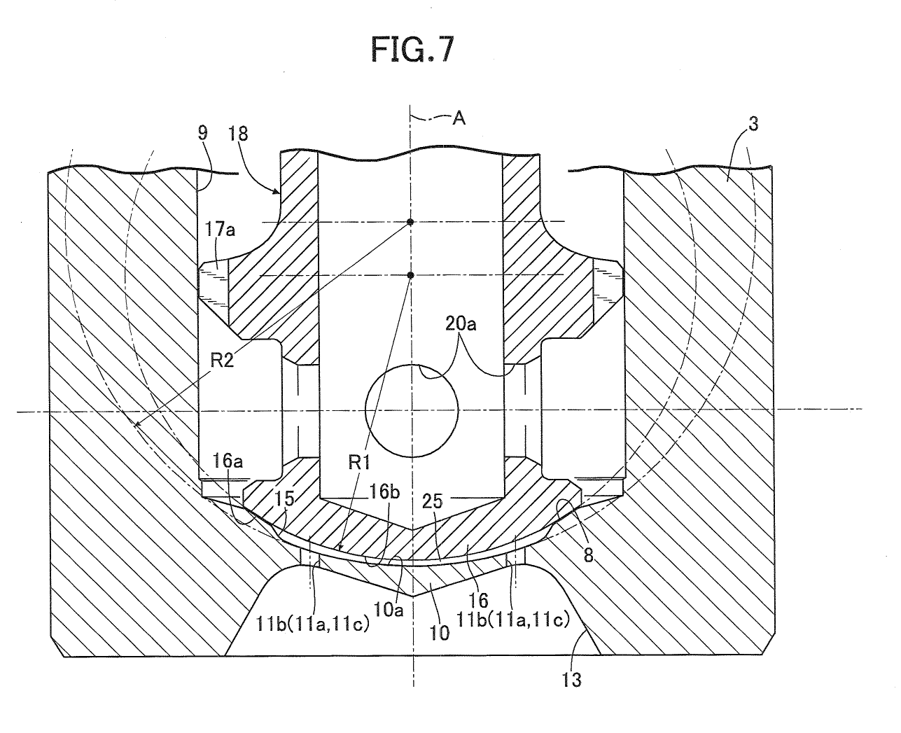

In FIG. 1, first and second intake ports P1 and P2 are formed in a cylinder head Eh of an engine E so as to correspond to one cylinder Ec, the first and second intake ports P1 and P2 being bifurcated with a partition wall Eha interposed therebetween, and openings of the first and second intake ports P1 and P2 to the cylinder Ec are opened and closed by a pair of intake valves Ei and Ei. Joined to one side of the cylinder head Eh is an intake manifold Em equipped with an intake path communicating in common with the first and second intake ports P1 and P2. A fuel injection valve I of the present invention is mounted in this intake manifold Em, and when it is open two independent fuel spray-form beams F1 and F2 produced by injected fuel are supplied toward the first and second intake ports P1 and P2. Here, the direction in which the first and second intake ports P1 and P2 are arranged on a front end face of the fuel injection valve I is defined as X, and the direction perpendicular to the arrangement direction X is defined as Y.

The fuel injection valve I is now explained by reference to FIG. 2 to FIG. 6.

First, in FIG. 2 and FIG. 3, a valve housing 2 of the fuel injection valve I is formed from a cylindrical valve seat member 3 having a valve seat 8 at the front end, a magnetic cylindrical body 4 coaxially and liquid-tightly joined to a rear end part of this valve seat member 3, a non-magnetic cylindrical body 6 coaxially and liquid-tightly joined to the rear end of this magnetic cylindrical body 4, a fixed core 5 coaxially and liquid-tightly joined to the rear end of this non-magnetic cylindrical body 6, and a fuel inlet tube 26 provided so as to be connected coaxially to the rear end of the fixed core 5.

The valve seat member 3 has a cylindrical guide hole 9 and an annular valve seat 8 communicating with the front end of this guide hole 9, and a nozzle 10 positioned on the valve seat 8 inner peripheral side, that is, the downstream side, is formed integrally with this valve seat member 3. Specifically, the valve seat member 3 and the nozzle 10 are formed integrally by machining the same material. Furthermore, a recess 13 that the nozzle 10 faces is formed in a front end face of the valve seat member 3. A peripheral wall of this recess 13 protects the nozzle 10 from coming into contact with other objects. A plurality of fuel discharge holes 11 are bored in the nozzle 10 so as to provide communication between the interior and exterior thereof. Details of these fuel discharge holes 11 are explained later.

The hollow cylindrical fixed core 5 is liquid-tightly pressed into an inner peripheral face of the non-magnetic cylindrical body 6 from the rear end side, and the non-magnetic cylindrical body 6 and the fixed core 5 are thereby joined to each other coaxially. In this process, a portion of a front end part of the non-magnetic cylindrical body 6 that does not have the fixed core 5 fitted into it remains, and a valve-core assembly V is housed within the valve housing 2 in a section from said portion to the valve seat member 3.

This valve-core assembly V is formed from a valve body 18 and a movable core 12, the valve body 18 being formed from a valve part 16 that opens and closes with respect to the valve seat 8 and a valve rod part 17 that supports the valve part 16, and the movable core 12 being linked to the valve rod part 17 and positioned coaxially opposite to the fixed core 5 while extending from the magnetic cylindrical body 4 to the non-magnetic cylindrical body 6 and being inserted thereinto. The valve rod part 17 is formed so as to have a smaller diameter than that of the guide hole 9, and a radially projecting journal portion 17a is formed integrally with the outer periphery of the valve rod part 17, the journal portion 17a being slidably supported on an inner peripheral face of the guide hole 9. Moreover, a journal portion 17b is formed on the outer periphery of the movable core 12, the journal portion 17b being slidably supported on an inner peripheral face of the magnetic cylindrical body 4.

The valve-core assembly V is provided with a lengthwise hole 19 extending from a rear end face of the movable core 12 to just before the valve part 16, a plurality of first sideways holes 20a providing communication between this lengthwise hole 19 and the outer peripheral face of the movable core 12, and a plurality of second sideways holes 20b providing communication between the lengthwise hole 19 and an outer peripheral face of the valve rod part 17 between the journal portion 17a and the valve part 16. In this arrangement, an annular spring seat 24 facing the fixed core 5 side is formed partway along the lengthwise hole 19.

The fixed core 5 is made of a high hardness ferrite magnetic material. On the other hand, a collar-shaped high hardness stopper element 14 surrounding the valve spring 22 is embedded in an attracting face of the movable core 12 that faces an attracting face of the fixed core 5. The outer end of the stopper element 14 projects slightly from the attracting face of the movable core 12, and is usually positioned opposing the attracting face of the fixed core 5 across a gap corresponding to the valve-opening stroke of the valve body 18.

The fixed core 5 has a lengthwise hole 21 communicating with the lengthwise hole 19 of the movable core 12, and the fuel inlet tube 26 is provided integrally with the rear end of the fixed core 5, the interior of the fuel inlet tube 26 communicating with the lengthwise hole 21. The fuel inlet tube 26 is formed from a decreased diameter portion 26a connected to the rear end of the fixed core 5 and an increased diameter portion 26b that is continuous with the decreased diameter portion 26a, and the valve spring 22 is provided in a compressed state between the spring seat 24 and a pipe-shaped retainer 23 fitted into and fixed to the lengthwise hole 21 from the decreased diameter portion 26a, the valve spring 22 urging the movable core 12 toward the side on which the valve body 18 is closed. In this process, the set load of the valve spring 22 is adjusted by the depth to which the retainer 23 is fitted into the lengthwise hole 21. A fuel filter 27 is fitted into the increased diameter portion 26b.

A coil assembly 28 is fitted around the outer periphery of the valve housing 2 so as to correspond to the fixed core 5 and the movable core 12. This coil assembly 28 is formed from a bobbin 29 and a coil 30 wound therearound, the bobbin 29 being fitted onto outer peripheral faces from a rear end part of the magnetic cylindrical body 4 to the fixed core 5, the front end of a cylindrical coil housing 31 surrounding the coil assembly 28 is welded to an outer peripheral face of the magnetic cylindrical body 4, and the rear end thereof is welded to an outer peripheral face of a yoke 5a projecting in a flange shape from the outer periphery of a rear end part of the fixed core 5.

Part of the magnetic cylindrical body 4, the coil housing 31, the coil assembly 28, the fixed core 5, and the front half of the fuel inlet tube 26 are encapsulated by a cylindrical molded part 32 made of a synthetic resin by injection molding. In this process, the interior of the coil housing 31 is also filled with the molded part 32 so as to also encapsulate the coil 30. A coupler 34 is formed integrally with a middle part of the molded part 32 so as to project toward one side, and this coupler 34 retains an energization terminal 33 connected to the coil 30.

As is clearly shown in FIG. 3, the annular valve seat 8 has as a basic shape a conical face whose diameter decreases in going toward the front of the fuel injection valve I, a seat part thereof for the valve part 16 is convexly curved, an annular sealing face 16a of the valve part 16 opposing the seat part is formed from part of a convex spherical surface, and an extremity face 16b of this valve part 16 is formed as a conical face having a tangent to the sealing face 16a as a generatrix.

On the other hand, with regard to the nozzle 10, both an inner end face 10a and an outer end face thereof are formed as conical faces whose diameter decreases in going toward the front of the nozzle 10, and form an overall shape that is convex toward the front of the fuel injection valve I. Furthermore, an annular step 15 is provided between the valve seat 8 and the inner end face 10a of the nozzle 10, the annular step 15 ensuring that there is a conical space 25 between the valve part 16 and the inner end face 10a of the nozzle 10. The space 25 prevents mutual contact between the valve part 16 and the nozzle 10, gives certainty that the valve part 16 is seated on the valve seat 8, and contributes to ensuring valve sealing.

A plurality of fuel discharge holes 11a, 11b, and 11c bored in the nozzle 10 are now explained by reference to FIG. 3 to FIG. 6.

As shown in FIG. 4, the plurality of fuel discharge holes 11a, 11b, and 11c are arranged on the same virtual circle C having an axis A of the valve seat member 3 as the center and having a smaller diameter than that of the valve seat 8. These fuel discharge holes 11a, 11b, and 11c are divided symmetrically into a first fuel discharge hole group G1 and a second fuel discharge hole group G2 with as a boundary a plane N passing through the axis A and extending in the Y direction (the direction orthogonal to the arrangement direction of the first and second intake ports P1 and P2). Here, a gap D2 between adjacent fuel discharge holes 11a, 11b, and 11c of each of the fuel discharge hole groups G1 and G2 is set so as to be smaller than a gap D1 between the two fuel discharge hole groups G1 and G2.

In the illustrated example, the number of fuel discharge holes forming each of the fuel discharge hole groups G1 and G2 is three, that is, 11a to 11c. As shown in FIG. 3 and FIG. 6, the fuel discharge holes 11a, 11b, and 11c are arranged so that their center lines La, Lb, and Lc are substantially parallel to the axis A of the valve seat member 3. The angle formed between the center line La, Lb, Lc of each of the fuel discharge holes 11a, 11b, and 11c and the conical concave inner end face 10a of the nozzle 10 is an obtuse angle a on the side closer to the outer periphery of the nozzle 10 with respect to the center line La, Lb, and Lc, and an acute angle β on the side closer to the center of the nozzle 10 with respect to the center line La, Lb, Lc.

Furthermore, as shown in FIG. 4 and FIG. 5, with regard to each of the fuel discharge hole groups G1 and G2, the two fuel discharge holes 11a and 11c on opposite outer positions are arranged so that the two center lines La and Lc intersect each other at an intersection point Q in front of the nozzle 10 and toward one side, closer to the center of the nozzle 10, of an extension of the center line Lb of the fuel discharge hole 11b at the middle position or its vicinity of the respective fuel discharge hole group G1, G2.

The operation of this embodiment is now explained.

In a state in which the coil 30 is de-energized, the valve-core assembly V is pushed forward by means of the urging force of the valve spring 22 to thus seat the valve body 18 on the valve seat 8. In this state, fuel that has been fed under pressure from a fuel pump, which is not illustrated, to the fuel inlet tube 26 passes through the interior of the pipe-shaped retainer 23 and the lengthwise hole 19 and first and second sideways holes 20a and 20b of the valve-core assembly V, is held in readiness within the valve seat member 3, and is used for lubrication of a section around the journal portions 17a and 17b of the valve-core assembly V.

When the coil 30 is energized by the passage of current, magnetic flux generated thereby runs in sequence through the fixed core 5, the coil housing 31, the magnetic cylindrical body 4, and the movable core 12, the magnetic force thereof causes the movable core 12 of the valve-core assembly V to be attracted to the fixed core 5 against the set load of the valve spring 22, the valve part 16 of the valve body 18 is detached from the valve seat 8 of the valve seat member 3 as shown in FIG. 6, and high pressure fuel within the valve seat member 3 therefore flows into the nozzle 10 via the valve seat 8. During this process, with regard to the flow of fuel on the conical concave inner end face 10a of the nozzle 10, the main flow includes an inward flow S1, which flows directly from the valve seat 8 to the fuel discharge holes 11a, 11b, and 11c, and an outward flow S2, which passes between adjacent fuel discharge holes 11a, 11b, and 11c, comes together in a central part of the inner end face 10a, then advances radially outwardly, and flows into the fuel discharge holes 11a, 11b, and 11c.

Since the angle formed between the center lines La, Lb, and Lc of the fuel discharge holes 11a, 11b, and 11c and the conical concave inner end face 10a of the nozzle 10 is set at the obtuse angle α on the side closer to the outer periphery of the nozzle 10 with respect to the center lines La, Lb, and Lc, the angle formed between the direction of the inward flow S1 and one inside face, on the side closer to the outer periphery of the nozzle 10, of the fuel discharge holes 11a, 11b, and 11c is also an obtuse angle, and the inward flow S1 is straightened while being guided by said one inside face and flows outside the fuel discharge holes 11a, 11b, and 11c, the energy loss being thus very small.

On the other hand, since the angle between the center lines La, Lb, and Lc of the fuel discharge holes 11a, 11b, and 11c and the conical concave inner end face 10a of the nozzle 10 is set at the acute angle β on the side closer to the center of the nozzle 10a with respect to the center lines La, Lb, and Lc, the angle between the direction of the outward flow S2 and the other inside face, on the side closer to the center of the nozzle 10, of the fuel discharge holes 11a, 11b, and 11c is also an acute angle, and even though it flows into the fuel discharge holes 11a, 11b, and 11c the outward flow S2 is combined with the inward flow S1 while separating from said other inside face.

In this way, fuel injected from the fuel discharge holes 11a, 11b, and 11c produces fuel spray forms fa, fb, and fc as fuel films having an arc-shaped cross section with a convex face facing toward the outer periphery of the nozzle 10 as shown in FIG. 4 and FIG. 6. Therefore, since the fuel spray forms fa, fb, and fc are produced as fuel films having an arc-shaped cross section, the outline is clear and wasteful scattering does not occur and, moreover, since the loss of fuel injection energy is small overall, the penetration properties of the fuel spray forms fa, fb, and fc can be improved.

Furthermore, the fuel films having an arc-shaped cross section producing the fuel spray forms fa, fb, and fc increase in diameter and greatly decrease in film thickness in going toward the intake valve Ei of the engine E, and finally exhibit a good atomization state as a result of high speed contact with air, and it is therefore possible to improve the atomization at the extremities of the fuel spray forms fa, fb, and fc close to the intake valve Ei.

In each of the first and second fuel discharge hole groups G1 and G2, three fuel spray forms fa, fb, and fc as arc-shaped cross section fuel films injected and produced from the three fuel discharge holes 11a, 11b, and 11c as described above form two independent, that is, first and second, fuel spray-form beams F1 and F2, and these first and second fuel spray-form beams F1 and F2 are supplied to the first and second intake ports P1 and P2 respectively.

The outlines of these fuel spray-form beams F1 and F2 are also clear, there is no wasteful scattering, and high penetration properties can be obtained.

In particular, in each of the fuel discharge hole groups G1 and G2, since the two fuel discharge holes 11a and 11c on opposite outer positions are arranged so that the two center lines La and Lc intersect each other at an intersection point Q in front of the nozzle 10 and toward one side, closer to the center of the nozzle 10, of an extension of the center line Lb of the fuel discharge hole 11b at the middle position or its vicinity of the respective fuel discharge hole group G1, G2, the fuel spray forms fa and fc injected and produced from the two fuel discharge holes 11a and 11c on opposite outer positions are inclined toward the fuel spray form fb injected and produced from the fuel discharge hole 11b at the middle position, the fuel spray-form beams F1 and F2 having clear outlines can be produced, and this can enhance further effectively the penetration properties of the fuel spray-form beams F1 and F2. The fuel spray-form beams F1 and F2 having thus enhanced penetration properties are resistant to becoming attached to an inner wall of the first and second intake ports P1 and P2, the engine combustion efficiency can be improved, and a contribution to an improvement of output and fuel consumption performance can be made.

Moreover, in each of the fuel discharge hole groups G1 and G2, since the center lines La, Lb, and Lc of the fuel discharge holes 11a, 11b, and 11c are substantially parallel to the axis A of the valve seat member 3, machining of each of the fuel discharge holes 11a, 11b, and 11c by means of piercing or a laser can be carried out easily without being affected by surrounding objects, such as a peripheral wall of the valve seat member 3.

Furthermore, since the valve seat member 3 and the nozzle 10 are integrated using the same material, not only can a step of joining to the valve seat member 3 by welding, etc. be omitted and the production step and the structure be simplified, but it is also possible to prevent the valve seat 8 from being distorted by a joining step and improve the precision of the valve seat 8 and, consequently, the valve sealing. Furthermore, it is possible to easily carry out machining of the fuel discharge holes 11a, 11b, and 11c at the correct positions with respect to the valve seat 8, and dimensional control can also be carried out easily.

FIG. 7 shows a modified example of the fuel injection valve I.

In this modified example of the present invention, an extremity face 16b of a valve part 16 is formed from a spherical face having the same diameter R1 as that of a valve seat 8, and an inner end face 10a of a nozzle 10 opposing the extremity face 16b is formed from a spherical face having a diameter R2 that is larger than the diameter R1. The arrangement thereof is the same as the preceding embodiment; portions in FIG. 7 corresponding to the preceding embodiment are denoted by the same reference numerals and symbols, and duplication of the explanation is therefore omitted. In accordance with this modified example, the same operational effects as those of the preceding embodiment can also be exhibited.

The present invention is not limited to the above-mentioned embodiment and may be modified in a variety of ways as long as the modifications do not depart from the spirit and scope thereof. For example, the number of the plurality of fuel discharge holes 11a, 11b, and 11c forming each of the fuel discharge hole groups G1 and G2 may be any of two or greater for the invention of claims 1 and 2 and may be any of three or greater for the invention of claim 3.

1. A fuel injection valve in which, in a state in which the fuel injection valve is mounted on an intake manifold (Em) of an internal combustion engine, two independent fuel spray-form beams (F1, F2) produced from injected fuel are supplied toward first and second ports (P1, P2), the fuel injection valve comprising a valve body (18), a valve seat member (3) having an annular conical valve seat (8) on which the valve body (18) is seated in an openable and closable manner, and a nozzle (10) that has a plurality of fuel discharge holes (11a, 11b, 11c) and is provided in a front end part of the valve seat member (3) so as to be positioned on the downstream side of the valve seat (8), an inner end face (10a) of the nozzle (10), on which inlets of the plurality of fuel discharge holes (11a, 11b, 11c) open, being a conical or spherical face that is concave in going toward the front of the nozzle (10),
characterized in that the plurality of fuel discharge holes (11a, 11b, 11c) are arranged on the same virtual circle (C) having an axis (A) of the valve seat member (3) as the center, these fuel discharge holes (11a, 11b, 11c) being divided into first and second fuel discharge hole groups (G1, G2) each comprising at least three fuel discharge holes (11a, 11b, 11c) producing the fuel spray-form beam (F1, F2),
the angle formed between the center line (La, Lb, Lc) of each of the fuel discharge holes (11a, 11b, 11c) and the inner end face (10a) of the nozzle (10) is set at an obtuse angle (α) on the side closer to the outer periphery of the nozzle (10) with respect to the center line (La, Lb, Lc) and an acute angle (β) on the side closer to the center of the nozzle (10) with respect to the center line (La, Lb, Lc), and
fuel discharge holes (11a, 11c) positioned on opposite outermost sides of each of the fuel discharge hole groups (G1, G2) are arranged so that the center lines (La, Lc) thereof intersect each other at an intersection point (Q) in front of the nozzle (10) and toward one side, closer to the center of the nozzle (10), of an extension of the center line (Lb) of the fuel discharge hole (11b) positioned at the middle or the vicinity of the respective fuel discharge hole group (G1, G2).

2. The fuel injection valve according to claim 1, wherein
the first and second fuel discharge hole groups (G1, G2) are positioned on opposite sides of one plane (N) containing the axis (A) as a boundary, and a gap (D2) between the fuel discharge holes (11a, 11b, 11c) in each of the fuel discharge hole groups (G1, G2) is set smaller than a gap (D1) between the two fuel discharge hole groups (G1, G2).

3. (canceled)

4. The fuel injection valve according to claim 1 or 2, wherein
the valve seat member (3) and the nozzle (10) are formed integrally using the same material.
